(19) United States
(12) Patent Application Publication
(10) Pub. No.: US 2026/0004223 A1
(43) Pub. Date: Jan. 1, 2026

(54) System and Method for Agent-Driven Property Valuation and Incentive-Based Real Estate Scoring

(71) Applicants: Ari Kyle Levine, Santa Monica, CA (US); Jason Ling, Sherman Oaks, CA (US); Jamie Tian, Sherman Oaks, CA (US); Joshua Spooner, Los Angeles, CA (US)

(72) Inventors: Ari Kyle Levine, Santa Monica, CA (US); Jason Ling, Sherman Oaks, CA (US); Jamie Tian, Sherman Oaks, CA (US); Joshua Spooner, Los Angeles, CA (US)

(21) Appl. No.: 19/097,709

(22) Filed: Apr. 1, 2025

Related U.S. Application Data
(60) Provisional application No. 63/666,358, filed on Jul. 1, 2024.

(51) Int. Cl. G06Q 10/0639; G06N 20/20; G06Q 50/16; H04L 9/40

(52) U.S. Cl. CPC G06Q 10/06398; G06N 20/20; G06Q 50/16; H04L 63/0823; G06Q 2220/00; H04L 2463/082

(57) ABSTRACT

A distributed computing system and method for evaluating real estate agent performance through cryptographically secured, GPS-validated estimate submissions, scored by a machine learning-optimized algorithm with dynamically adjusted weightings. The Agent Competency and Credibility Score (ACCS) provides a transparent, technically verified trust metric combining price accuracy, geospatial expertise verification, property-type specialization, and statistical confidence calibration. The system implements a novel hybrid data architecture that maintains sensitive estimation data in secure encrypted databases while utilizing blockchain technology exclusively for transparent reward distribution, solving critical technical challenges in data security, computational efficiency, and incentive alignment.

### CROSS-REFERENCE TO RELATED APPLICATIONS

This application claims the benefit of U.S. Provisional Patent Application No. 63/666,358, filed Jul. 1, 2024, entitled ‘ESTIMATE TO EARN SYSTEM AND METHOD,’ the contents of which are incorporated herein by reference.

### FIELD OF THE INVENTION

The present disclosure relates to distributed computing systems and methods for measuring real estate agent performance and credibility through structured data collection, cryptographically secure scoring algorithms, statistical confidence calibration, secure database partitioning, and tokenized incentive mechanisms. It further integrates geolocation verification modules, MLS data integration protocols, and selective blockchain-based reward tracking to enhance real estate transaction trust and transparency while solving technical challenges in data security, privacy, and system performance.

### BACKGROUND OF THE INVENTION

Traditional real estate technology platforms suffer from significant technical limitations, including but not limited to: (i) centralized database architectures that create single points of failure for sensitive valuation data; (ii) inability to reliably verify agent physical presence at properties, leading to low-quality remote estimates; (iii) statistically unreliable valuation methodologies that fail to incorporate confidence calibration or specialized expertise indicators; (iv) vulnerability to automated gaming and manipulation due to lack of robust verification protocols; (v) inefficient data storage practices that place confidential information in inappropriate technological environments; and (vi) computationally inefficient scoring algorithms that fail to incorporate dynamic machine learning optimizations.

Existing automated valuation models (AVMs) utilize static algorithmic approaches with limited ability to incorporate real-time human expertise or physical property inspection data. U.S. Pat. No. 9,605,704 describes a computerized valuation system but fails to incorporate physical verification or dynamic confidence calibration. Similarly, U.S. Pat. No. 10,380,653 discloses a property valuation platform but relies entirely on historical transaction data without addressing the technical challenges of real-time expert input validation or secure data partitioning.

Current blockchain-based real estate systems, such as those described in U.S. Pat. No. 11,042,838, attempt to store all transaction data on-chain, creating unsustainable computational overhead, privacy vulnerabilities, and system latency. Meanwhile, conventional agent rating platforms like those in U.S. Pat. No. 10,643,246 rely on subjective customer reviews rather than objective, mathematically rigorous performance metrics verified through secure technical means.

There exists a clear technical need for: (i) a hybrid data architecture that appropriately partitions sensitive and non-sensitive data across secure databases and blockchain ledgers; (ii) computationally efficient algorithms for confidence calibration and agent scoring; (iii) technically robust anti-gaming verification methods incorporating geolocation and temporal constraints; and (iv) secure, distributed incentive mechanisms that maintain data privacy while ensuring transaction transparency.

### SUMMARY OF THE INVENTION

The present invention provides a distributed computing system and method that solves the technical problems of secure data partitioning, agent identity verification, computational confidence calibration, and performance-based incentivization through a novel architecture comprising:

A distributed data architecture that maintains estimation data in secure, encrypted databases while utilizing a blockchain ledger exclusively for immutable reward recording, thereby achieving both privacy and verification through technical separation of concerns;

A computationally efficient verification module utilizing GPS triangulation, cellular network validation, and temporal constraints to confirm agent physical presence at properties before allowing data submission;

A statistically optimized Agent Competency and Credibility Score (ACCS) calculation engine that employs machine learning algorithms to dynamically adjust weighting parameters based on market conditions and statistical performance;

A novel confidence calibration algorithm that quantitatively measures the correlation between agent self-assessment and actual performance, providing a computational mechanism for metacognitive evaluation;

A technical anti-gaming framework incorporating anomaly detection algorithms, time-series analysis, and secure one-way submission protocols to prevent system manipulation;

A selective blockchain implementation that records only reward transactions, solving the technical challenges of blockchain scalability while preserving the benefits of immutable transaction recording for incentive distribution.

The system achieves technical improvements in data security, computational efficiency, statistical reliability, and verification robustness compared to existing solutions, while maintaining a distributed architecture that prevents single points of failure.

### BRIEF DESCRIPTION OF DRAWINGS

FIG. 1: System Architecture Diagram: illustrates the high-level architecture of the RealiFi ACCS system. The Mobile Client Application [101] interacts with Location Services [102] to determine agent position. It communicates via an Encrypted API [103] with the Application Server Layer [104], which utilizes Authentication Services [105] for security. The main processing is performed by three engines: the Estimation Engine [106], Scoring Engine [107], and Reward Engine [108]. Estimation and scoring data are stored in the Data Storage Layer [109], while only reward data is recorded on the Blockchain Reward Ledger [110] as noted in the diagram [111]. This separation ensures that sensitive estimation data remains in secure traditional databases while only the token-based rewards utilize blockchain technology.

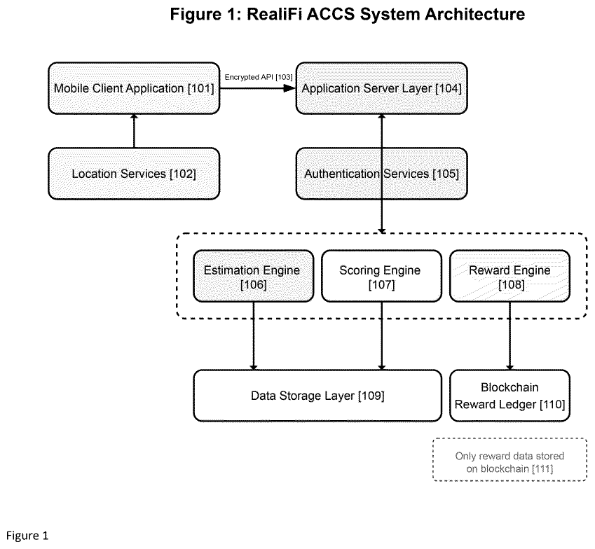

FIG. 2: Estimation Workflow Process: depicts the sequential workflow of the estimation process, beginning with Agent Login [201], followed by Property Selection [202], and GPS Check-in Verification [203]. Once verified, the agent proceeds to Estimate Submission and Data Validation [204, 205]. The system then performs Secure Database Storage [206] of the estimation data, updates the Temporary Score [207], and initiates Property Status Monitoring [208]. Upon Sale Completion Detection [209], the system calculates the Final Score [210] and distributes rewards through the Blockchain Reward Distribution [211] system. As indicated by the note [212], only the reward distributions are recorded on the blockchain, not the estimation data itself.

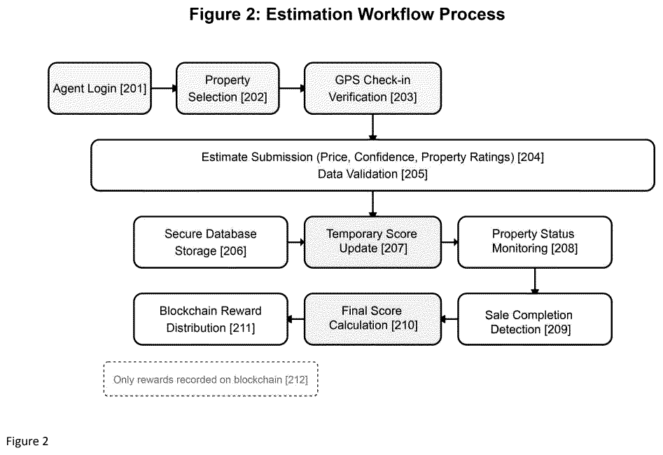

FIG. 3: Data Flow Diagram: shows the data flow throughout the system. Starting with the Agent Mobile App [301], data including estimates, geolocation, and agent identification [302] flows through the API Gateway [303] for authentication and validation. The Estimation Service [304] processes this data, interacting with the Property Database [305], MLS Integration [306], and External Property Data [307]. The Scoring Engine [308] calculates agent scores, while the Reward Distribution Engine [309] determines token allocations. Estimation data is stored in the Estimation Data Storage [312] system, while only reward information is sent to the Blockchain Service [310] as noted [313]. The Notification Service [311] alerts users of relevant events, including rewards and score changes.

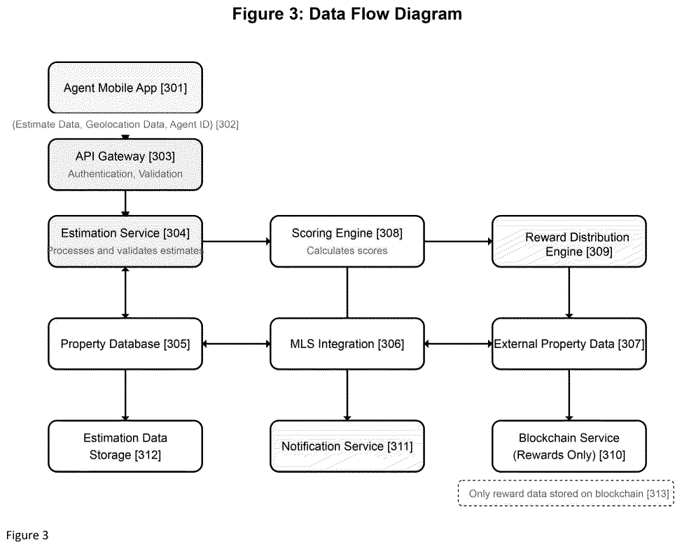

FIG. 4: Mobile Interface Design: illustrates the user interface components of the RealiFi mobile application. The Property Map [401] displays available listings with a Check In button [402] that activates when an agent is at a property location. The Property Details screen [403] shows listing information, including address [404] and an Estimate button [405]. The Estimate Submission screen [406] contains input fields for Estimated Price [407], Confidence Level [408], and Property Ratings [409], along with a Submit button [410] to complete the process. A separate Rewards Screen [411] displays blockchain-based tokens [412] earned through accurate estimates.

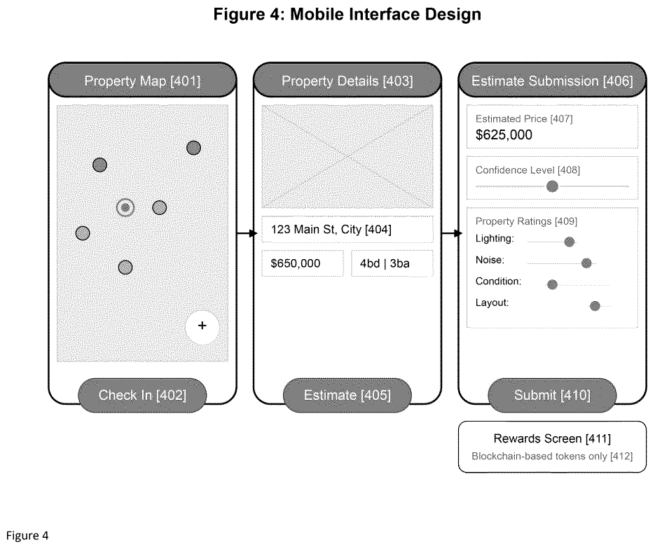

FIG. 5: ACCS Algorithm Components: visualizes the components of the Agent Competency and Credibility Score (ACCS) [501] algorithm. The score combines five weighted factors: Estimate Price Accuracy (EPA) [502], Estimate History Accuracy (EHA) [503], Local Specialization Accuracy (LSA) [504], Property Type Accuracy (PTA) [505], and General Estimation Activity (GEA) [506]. The Confidence Calibration (CC) [507] component serves as a multiplier on the combined score. The mathematical formula [508] shows how these components are weighted (w₁=0.40 [509], w₂=0.25 [510], w₃=0.15 [511], w₄=0.15 [512], w₅=0.05 [513]) and multiplied by the CC factor [514]. The Bayesian Update Engine [515] continuously refines these weights based on new data. The ACCS score feeds into the Token Reward System [516], which calculates incentives with only reward data stored on the blockchain [517].

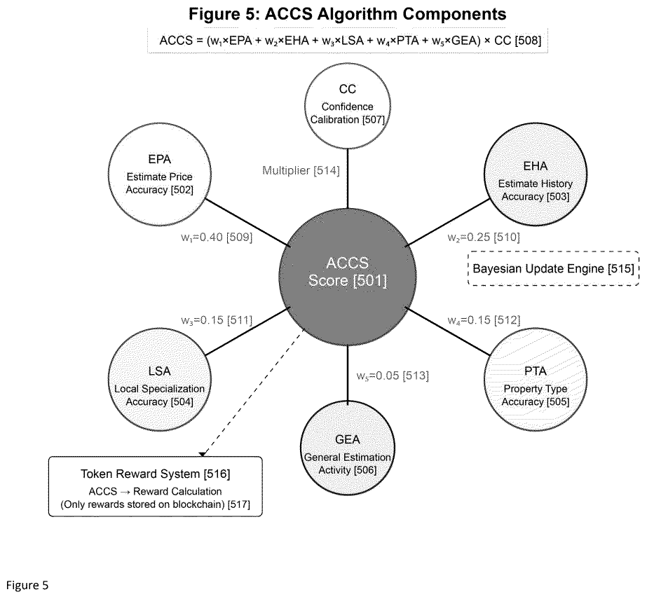

FIG. 6: Database Architecture Diagram: illustrates the technical implementation of the secure data partitioning system. The diagram shows the Primary Estimation Database [601] with encrypted agent submissions and property details. This connects to the Scoring Computation Engine [602] which processes data through the Machine Learning Optimization Module [603]. The Blockchain Interface Layer [604] selectively transmits only reward data through a One-Way Data Diode [605] to the Blockchain Network [606]. The Security Boundary [607] ensures that sensitive data cannot flow backward through the system. The Real-Time Cache Layer [608] optimizes read operations for frequently accessed data while maintaining security isolation.

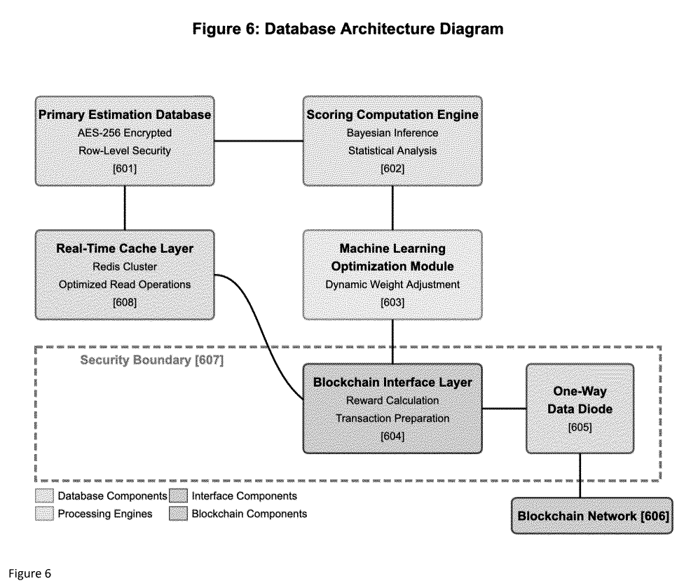

FIG. 7: Machine Learning Model Architecture: details the technical implementation of the Bayesian updating system. The Neural Network Structure [701] shows the input layer accepting raw estimation data [702], multiple hidden layers [703,704,705] with varying activation functions, and the output layer [706] producing optimized weighting parameters. The Training Pipeline [707] shows how historical estimation data flows through Data Preprocessing [708], Feature Extraction [709], Model Training [710], and Validation [711] stages. The Deployment Workflow [712] illustrates how the trained model is securely deployed to the production environment through Model Serialization [713], Verification Testing [714], and Secure Deployment [715] stages.

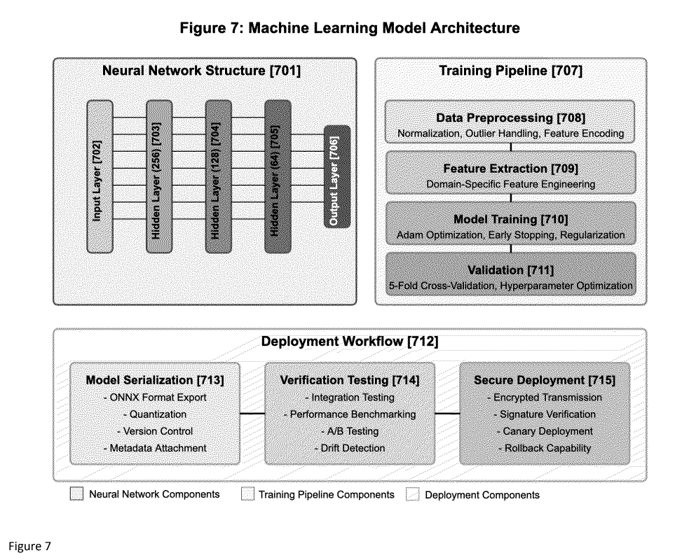

FIG. 8: API Security Architecture: depicts the technical implementation of the secure communication protocol. The diagram shows the Mobile Client [801] sending encrypted requests through TLS 1.3 [802] to the API Gateway [803]. Requests pass through Multiple Authentication Layers [804] including JWT Validation [805], API Key Verification [806], and Rate Limiting [807]. The request then proceeds to the Input Validation Layer [808] where it undergoes Schema Validation [809], Sanitization [810], and Business Rule Verification [811]. Finally, the validated request reaches the Application Logic [812] which interacts with the Database through a Query Protection Layer [813] implementing Prepared Statements [814] and Permission Checking [815].

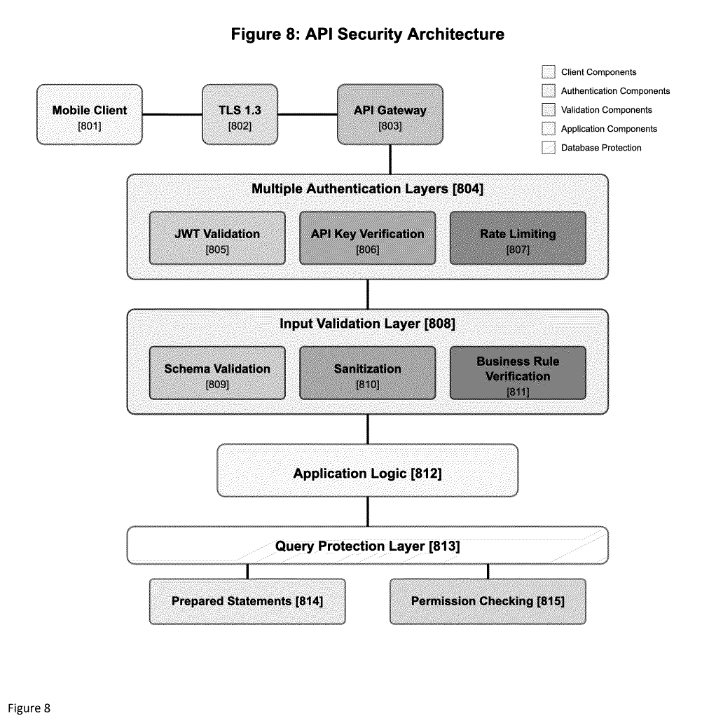

### DETAILED DESCRIPTION OF THE INVENTION

The Agent Competency and Credibility Score (ACCS) is computed using a multi-factor weighted algorithm that adapts to market conditions and agent performance patterns. The formula for calculating the ACCS is:

$$ACCS = ( {w}_{1} \times EPA ) + ( {w}_{2} \times EHA ) + ( {w}_{3} \times LSA ) + ( {w}_{4} + PTA ) + ( {w}_{5} \times GEA ) \times CC$$

Where:
EPA (Estimate Price Accuracy): Calculated as 1−|Estimated Price−Final Sale Price|/Final Sale Price
EHA (Estimate History Accuracy): Measure of historical estimation accuracy weighted by recency
LSA (Local Specialization Accuracy): Measure of accuracy within specific geographic subdivisions
PTA (Property Type Accuracy): Measure of accuracy within specific property categories
GEA (General Estimation Activity): Volume and consistency of estimate submissions
CC (Confidence Calibration): Correlation coefficient between agent's self-reported confidence and actual accuracy
w₁, w₂, w₃, w₄, w₅: Dynamically adjusted weights based on market conditions and data availability

The system employs a Bayesian updating mechanism where each new estimate and subsequent sale result updates the agent's score components. The initial weights are set as follows:
w₁ (EPA weight): 0.40
w₂ (EHA weight): 0.25
w₃ (LSA weight): 0.15
w₄ (PTA weight): 0.15
w₅ (GEA weight): 0.05

These weights are periodically recalibrated using machine learning techniques to optimize the predictive power of the ACCS with respect to future estimation accuracy.

In some embodiments, the system periodically re-optimizes the weighting parameters (w₁-w₅) and the Bayesian update factors used in the ACCS by utilizing machine learning models. For instance, a regression model or neural network may be trained on historical data to predict which weighting distribution yields the highest correlation between intermediate ACCS values and final transaction outcomes (e.g., final sale prices). Periodically (e.g., weekly or monthly), the system updates these weight parameters by: collecting real estate transaction data and comparing predicted versus actual outcomes, evaluating the current weighting's performance based on accuracy and stability, and adjusting the weighting parameters to minimize prediction error or maximize correlation with final sale prices.

This iterative, data-driven approach adapts the scoring algorithm to evolving market conditions (e.g., increased volatility in certain neighborhoods or property types) and agent behavior patterns. As a result, the Bayesian updating mechanism benefits from dynamically tuned priors, ensuring that high-performing agents are more accurately distinguished from less-reliable participants in changing environments.

Confidence Calibration Method: The Confidence Calibration (CC) component is a unique feature that measures how well an agent's self-reported confidence aligns with their actual accuracy. The calculation process involves: for each estimate submission, the agent provides a confidence level (CL) on a scale of 1-5, the system converts this to a normalized confidence score (NC) between 0 and 1, for each closed transaction, the system calculates the absolute percentage error (APE), the Confidence Calibration is calculated as:

$$CC = 1 - \vert Pearson correlation coefficient ( NC , 1 - APE ) \vert$$

The CC score rewards agents whose confidence assessments accurately reflect their knowledge boundaries. This mechanism discourages both overconfidence and underconfidence, promoting honest self-assessment.

To further incentivize honest self-reporting and robust self-awareness, the system may categorize agents into confidence tiers (e.g., Tier A, Tier B, Tier C) based on their historical correlation between self-reported confidence and actual accuracy. For instance:
Tier A (Highly Calibrated): Correlation coefficient above 0.80
Tier B (Moderately Calibrated): Correlation coefficient between 0.50 and 0.80
Tier C (Poorly Calibrated): Correlation coefficient below 0.50

Agents in higher tiers may receive additional reward multipliers when their valuations are confirmed accurate, reflecting the system's trust in their self-assessment. Conversely, Tier C agents receive a neutral or reduced multiplier to encourage more realistic confidence scoring. The system updates an agent's tier dynamically following each transaction, allowing them to move between tiers as they improve or regress in self-awareness.

Anti-Gaming Measures: To maintain system integrity, the following anti-gaming measures are implemented: (i) Single-Submission Restriction: Each agent is permitted to submit only one valuation estimate per property listing. Once an agent's estimate is recorded, no revisions or additional estimates may be made by the same agent unless the property is sold, delisted, or otherwise taken off the market. This restriction ensures that each valuation truly reflects the agent's initial, best-informed assessment. (ii) Outlier Detection: Statistical anomaly detection identifies and flags suspicious valuation patterns that deviate significantly from typical market ranges or from an agent's historical accuracy. Flagged valuations may trigger additional reviews or reduced weighting. (iii) Geolocation Verification: GPS check-in with triangulation verification ensures the agent is physically present at the property at the time of submission, mitigating remote guesswork. (iv) Temporal Constraints: Minimum time requirements between property check-ins prevent agents from rapidly hopping among multiple listings to inflate submission counts. This discourages hasty or non-diligent valuations. (v) Activity Pattern Analysis: Machine learning algorithms detect suspicious activity patterns indicating potential gaming behaviors, such as a sudden, improbable spike in submitted valuations across various properties or abrupt shifts in an agent's typical accuracy profile. (vi) By combining single-submission limits, outlier detection, location verification, temporal constraints, and ML-driven activity analyses, the system deters fraudulent or exploitative actions and fosters a higher standard of accuracy and trust in the valuation process.

Reward System and Blockchain Implementation: The reward system exclusively utilizes blockchain technology for the storage and distribution of token-based rewards, while all estimation data, scoring information, and other sensitive details are stored in conventional secure databases. This approach maintains data privacy while leveraging the transparency and immutability benefits of blockchain for the incentive layer. Rewards are calculated based on: (i) estimation accuracy: Proximity to final sale price, (ii) time-to-close factor: For seller rewards, faster sales receive proportionally higher rewards, and (iii) market-specific adjustments: Rewards are calibrated to local market conditions

Only the following data is recorded on the blockchain: final reward calculations, token distributions to agents, sellers, and other stakeholders, transaction timestamps, and reward parameters.

All estimation data, property details, and agent scoring metrics remain in traditional secure databases to ensure privacy and system performance.

Example Use Case: Single Submission, Confidence Calibration, and Token Rewards: Consider a real estate property listed at 123 Main Street. Agent “Alice” arrives onsite to provide a single valuation estimate for this listing: (i) Onsite Check-In & Submission: Alice opens the mobile application, which verifies her GPS location to confirm she is physically present at the property. (ii) She inputs a valuation estimate of $500,000 and selects a confidence level of 4 out of 5. (iii) No Revisions: Because the system limits agents to one submission per listing, Alice cannot revise her estimate later. This ensures she provides her best-informed valuation from the start. (iv) Preliminary Scoring & Calibration: The Scoring Engine records Alice's estimate and compares it to relevant reference data (such as neighborhood comps or historical trends), generating a preliminary accuracy metric. (v) The Confidence Calibration Module reviews Alice's past performance. It calculates how accurately her self-reported confidence correlated with actual sale outcomes in prior transactions. (vi) A Bayesian Inference Engine then updates Alice's Agent Competency & Credibility Score (ACCS), factoring both the new estimate and her historical correlation. (vii) Anomaly Detection (if applicable): If Alice's estimate appeared highly deviant from typical property comps or from her own track record, the Anomaly Detection sub-module might flag it for reduced weighting or further review. In this example, assume her estimate is within acceptable bounds. (viii) Sale Event & Final Accuracy: Several weeks later, the property sells for $490,000. The system compares Alice's $500,000 estimate to the final sale price, calculating an absolute percentage error of about 2%. (ix) This error figure updates her ACCS again, with her confidence correlation factoring into whether she's “accurately self-aware.” If Alice consistently matches her stated confidence, she could receive a reward multiplier per the system's tier-based incentive. (x) Blockchain-Recorded Reward: Once the sale is confirmed, the Reward Distribution module computes her final token payout based on the updated ACCS. (xi) A transaction is written to the blockchain ledger, recording only the reward specifics—e.g., token amount and timestamp. All other sensitive data (property details, raw estimate, Alice's historical metrics) remains off-chain in secure databases. (xii) This hybrid approach preserves privacy while providing a verifiable on-chain record of the incentive granted. (xiii) Outcome & Future Listings: Alice can now view her updated ACCS, confidence calibration tier, and token reward within the application's user interface. (xiv) Should the property be re-listed or if Alice moves on to a new property, she can submit a new valuation. However, she cannot return and revise her prior estimate for 123 Main Street once it's sold or taken off the market.

This scenario demonstrates the synergy of the system's core elements: single-submission prevents guesswork or repeated attempts. Geolocation verification confirms onsite presence. Bayesian updates+confidence calibration refine the agent's credibility score. Anomaly detection flags outliers. Selective blockchain storage secures reward records while keeping sensitive data private. By integrating these features, the platform fosters more truthful, accurate, and trustworthy real estate valuations.

Technical Advantages and Non-Trivial Synergy: The combination of (i) a single-submission restriction for each agent per property, (ii) a confidence calibration mechanism that quantitatively measures self-awareness, and (iii) partial blockchain usage for token reward transactions offers significant technical advantages over conventional approaches. By enforcing only one estimate per active listing, the system eliminates the “trial-and-error” behavior often seen in repeated submissions, ensuring each agent's valuation reflects their most accurate, best-informed judgment. Meanwhile, the confidence calibration module continuously adjusts how agent-estimated confidence aligns with measured outcomes, discouraging overconfidence or artificially conservative estimations. Furthermore, limiting the scope of on-chain data to final reward records—not the raw valuation data—dramatically reduces blockchain storage overhead, transaction fees, and latency, while preserving immutability and transparency for the critical reward layer. This hybrid design enhances privacy and system throughput compared to solutions that attempt to record large volumes of sensitive data on-chain. Together, these measures create a robust end-to-end valuation process that is technically efficient, highly secure against fraudulent manipulation, and practically scalable for the dynamic nature of real estate markets, distinguishing it from a mere abstract or purely business-oriented method.

Differentiation from Prior Art: Table 1: Distinguishing Features from Traditional Agent Rating Platform

| Feature | Traditional Platforms | ACCS System |
|---|---|---|
| Rating Basis | Subjective client reviews | Objective price accuracy |
| | | measurements |
| Verification | Self-reported transactions | GPS-verified physical |
| | | presence |
| Scoring | Overall satisfaction | Multi-factor specialized |
| Dimensions | | expertise scores |
| Data | Post-transaction surveys | Real-time property |
| Collection | | assessments |
| Gaming | Minimal (review | Comprehensive (geolocation |
| Prevention | validation) | time-weighted submissions) |
| Incentive | None or marketing | Token-based rewards |
| Structure | exposure | proportional to accuracy |
| Confidence | None | Self-calibrating confidence |
| Assessment | | measurement |
| Transparency | Black-box ratings | Transparent component- |
| | | based scoring |

Differentiation from Automated Valuation Models (AVMs): (i) Human Expert Layer: Unlike purely algorithmic AVMs, the ACCS system incorporates human expert judgment with real-time physical property inspection. (ii) Subjective Element Capture: The system captures subjective elements that AVMs cannot detect, such as property “feel,” visual appeal, and neighborhood ambiance. (iii) Real-Time Market Sentiment: By aggregating current agent estimates rather than relying solely on historical data, the system captures real-time market sentiment and pricing trends. (iv) Transparency and Explainability: While most AVMs operate as black boxes, the ACCS system provides transparent score components and confidence assessments. (v) Incentive Alignment: The system creates economic incentives for accurate estimation, whereas AVMs have no inherent accuracy incentives. (vi) Hybrid Methodology: By combining human expertise with algorithmic validation, the system addresses the limitations of both purely human and purely automated approaches.

Novel Technical Elements: (i) Confidence Calibration Correlation: The system's measurement of how well agents' self-assessed confidence correlates with actual accuracy represents a novel application of metacognitive assessment in real estate technology. (ii) Geolocation-Verified Expertise: The requirement for physical presence verified by GPS creates a verifiable chain of property visitation that distinguishes true local expertise. (iii) Blockchain-Recorded Rewards: The selective use of blockchain technology exclusively for reward distribution creates unprecedented transparency and accountability in agent incentivization while maintaining data privacy for sensitive estimation information. (iv) Token-Based Incentive Alignment: The economic reward mechanism based on accuracy creates a novel alignment of incentives between estimation providers and platform users. (v) Multi-Dimensional Expertise Scoring: The system's separation of expertise into geographic, property-type, and historical components allows for granular matching of agents to specific property requirements.

Secure Database Architecture Implementation: The system implements a multi-tiered database architecture to ensure data security, privacy, and optimal performance. The Primary Estimation Database utilizes row-level encryption with AES-256 for all sensitive agent and property data. Database access is managed through a Role-Based Access Control (RBAC) system with granular permissions that limit data visibility based on user type and authentication level. Database connections utilize TLS 1.3 with certificate pinning to prevent man-in-the-middle attacks. A separate Authentication Database stores hashed credentials using Argon2id with individually salted passwords. For performance optimization, frequently accessed data is cached in a Redis cluster with automatic invalidation triggers based on data modification events. To prevent SQL injection, all database queries are executed through parameterized prepared statements with input validation and sanitization. Separate read and write connection pools with connection limiting prevent denial of service attacks. Regular automated backups with point-in-time recovery capability ensure data durability while maintaining encryption throughout the backup process.

Machine Learning Implementation Details: The ACCS score optimization utilizes a hybrid machine learning approach combining gradient-boosted decision trees and neural networks. The Gradient Boosted Machine (GBM) component uses XGBoost with early stopping to identify key features correlated with estimation accuracy. Feature engineering processes include: preprocessing through normalization and outlier handling, encoding categorical variables using target encoding for property types and geographic regions, generating temporal features capturing market velocity and seasonality, and creating interaction terms between agent experience and property characteristics.

The neural network component consists of four hidden layers (256, 128, 64, 32 neurons) with Leaky ReLU activation functions and batch normalization, trained using Adam optimization with learning rate scheduling. Model training follows a 5-fold cross-validation protocol with hyperparameter optimization via Bayesian optimization. Regularization techniques include L2 regularization, dropout (0.3), and early stopping based on validation loss. The model is retrained weekly on new data, with continuous A/B testing of model variants to ensure performance improvement. Feature importance is calculated using SHAP values to ensure explainability of the model's predictions.

Geolocation Verification Technical Implementation: The geolocation verification module utilizes a multi-factor approach to confirm agent physical presence. Primary location is determined through GPS coordinates with error radius calculation. This is cross-validated through cellular tower triangulation when available, providing a secondary location verification independent of GPS. For additional security, the system captures device orientation data, barometric pressure (for elevation verification), and available Wi-Fi networks to create a location fingerprint.

A time-series analysis algorithm detects suspicious movement patterns incompatible with normal property visitation, such as impossibly rapid transitions between distant properties. The system implements GPS spoofing detection through consistency checking across multiple location indicators and temporal patterns. All location verification occurs on the server-side after receiving encrypted device data, preventing client-side manipulation. Location data undergoes fuzzy matching against property coordinates with configurable tolerance based on property size and GPS accuracy metrics specific to the device and environmental conditions.

Blockchain Integration Technical Specifications: The system utilizes a hybrid blockchain architecture with selective data storage. Only token reward transactions are recorded on a permissioned blockchain network running a Practical Byzantine Fault Tolerance (PBFT) consensus algorithm. Smart contracts governing reward distribution are implemented using Solidity with formal verification through the K framework to ensure mathematical correctness. Each transaction includes a cryptographic hash of the triggering event (property sale) without exposing the underlying sensitive data.

The blockchain component integrates with traditional databases through a secure one-way data diode pattern that prevents sensitive information from flowing onto the blockchain while allowing authorized reward calculations to trigger token distribution. Transaction batching reduces gas costs and improves system efficiency by combining multiple reward events into single blockchain transactions where appropriate. Zero-knowledge proofs are implemented for certain reward calculations, allowing verification of computation correctness without revealing the underlying property data. The system maintains a node infrastructure with geographic distribution to ensure high availability and resistance to regional outages.

API Security Implementation: The API layer implements multiple security mechanisms to ensure data integrity and access control. All API communications utilize mutual TLS (mTLS) with certificate-based authentication and perfect forward secrecy. API requests require multi-factor authentication through a combination of JWT tokens, API keys, and session validation. Request throttling is implemented using a token bucket algorithm with differentiated rate limits based on endpoint sensitivity and user role.

Input validation employs strict JSON schema validation with custom validators for domain-specific fields such as property identifiers and geolocation coordinates. The API implements Content Security Policy (CSP) headers, CORS restrictions, and protection against common attacks including CSRF, XSS, and request forgery. Large payload attacks are mitigated through configurable request size limits and streaming parser implementation for necessary large transfers. API permissions follow the principle of least privilege with authenticated endpoints having explicit permission requirements defined through a capability-based security model rather than role-based limitations.

Mobile Application Security: The mobile client implements certificate pinning to prevent man-in-the-middle attacks on API communications. Sensitive data, including authentication tokens and cached property information, is stored in the secure enclave (iOS) or equivalent secure storage (Android) with hardware-backed encryption. The application performs runtime integrity checking to detect jailbreaking/rooting and modified binaries, refusing to operate in compromised environments. Biometric authentication (fingerprint/facial recognition) is required for sensitive operations, with configurable session timeouts requiring re-authentication. The application implements secure offline operation modes with cryptographically signed data synchronization upon reconnection to prevent manipulation during offline periods.

1. A distributed computing system for evaluating real estate agent estimates and distributing token-based incentives, comprising: a. a network interface configured to receive data transmissions from remote mobile devices; b. a location verification processor configured to authenticate agent physical presence at a specific property through multi-factor verification comprising at least GPS coordinates, timestamp analysis, and cellular network triangulation; c. an estimation processing server comprising at least one processor and non-transitory memory storing instructions that, when executed, cause the processor to: i. receive, through the network interface, an agent-generated valuation estimate for the property and a self-reported confidence level; ii. validate the estimate through a series of computational validations including outlier detection and statistical consistency checking; iii. store the validated estimate in an encrypted database record; d. a scoring engine comprising at least one processor and non-transitory memory storing instructions that, when executed, cause the processor to: i. compute, using a machine learning model trained on historical property data, an initial accuracy metric by comparing the valuation estimate to multiple reference price sources; ii. determine a confidence calibration factor by calculating a statistical correlation between the agent's self-reported confidence level and actual historical accuracy data; iii. update an agent competency score through a Bayesian inference algorithm utilizing dynamically adjusted weighting parameters; e. a secure database system configured to: i. store estimate data, agent data, and property details in encrypted form with row-level security; ii. implement role-based access controls restricting data access based on authentication level; iii. maintain separate read and write connection pools with parameterized query execution; f. a blockchain interface module configured to: i. receive notification of property sale completion from an external data source; ii. calculate, upon such notification, a token reward amount based on the agent competency score and estimation accuracy; iii. transmit only the token reward transaction data to a blockchain network through a one-way data diode architecture; iv. record the reward transaction on the blockchain without exposing any sensitive property or agent data.

2. The system of claim 1, wherein the machine learning model comprises: a. a feature engineering pipeline that processes raw property and agent data into normalized numerical representations; b. a gradient boosted decision tree component that identifies key predictive features for estimation accuracy; c. a neural network component with at least three hidden layers using non-linear activation functions; d. a regularization mechanism implementing at least dropout and L2 regularization to prevent overfitting; e. a hyperparameter optimization module that periodically retrains the model with updated weighting parameters in response to new market data.

3. The system of claim 1, wherein the location verification processor implements a spoofing detection algorithm that: a. analyzes historical movement patterns to identify physically impossible location transitions; b. compares reported GPS coordinates against cellular network triangulation data to detect inconsistencies; c. verifies device orientation and environmental sensor data for consistency with reported location; d. implements a time-delay mechanism requiring minimum realistic transition times between property check-ins.

4. The system of claim 1, wherein the blockchain interface module implements: a. a smart contract governing reward distribution with formal verification of mathematical correctness; b. a transaction batching mechanism that combines multiple reward distributions to optimize computational efficiency; c. a zero-knowledge proof system allowing verification of reward calculations without revealing underlying property data; d. a permissioned blockchain network using a Byzantine Fault Tolerance consensus algorithm optimized for transaction throughput.

5. The system of claim 1, further comprising an anomaly detection subsystem that: a. builds agent-specific behavioral profiles based on historical estimation patterns; b. applies machine learning algorithms to identify statistically significant deviations from expected behavior; c. implements adaptive thresholds that adjust sensitivity based on market volatility and agent experience; d. flags suspicious patterns for human review while applying temporary weighting adjustments to potentially manipulated submissions.

6. The system of claim 1, wherein the network interface implements a secure communication protocol comprising: a. mutual TLS authentication with perfect forward secrecy; b. multi-factor API authentication combining token-based and certificate-based verification; c. rate limiting implemented through a token bucket algorithm with role-based thresholds; d. strict input validation using JSON schema verification and parameterized request processing.

7. The system of claim 1, wherein the secure database system implements: a. AES-256 encryption for all sensitive data fields with key rotation mechanisms; b. connection pooling with separate read and write pools to optimize performance and security; c. prepared statement execution for all database queries to prevent SQL injection; d. automated backup procedures with point-in-time recovery capability maintaining encryption throughout the backup process.

8. The system of claim 1, further comprising a mobile application that: a. implements certificate pinning to prevent man-in-the-middle attacks; b. stores authentication credentials in a hardware-backed secure enclave; c. performs runtime integrity checking to detect device compromises; d. implements secure offline operation with cryptographically signed data synchronization upon reconnection.

9. A method implemented by one or more computing devices for evaluating real estate agent estimates and distributing token-based incentives, the method comprising: a. receiving, through a secure network interface implementing mutual TLS authentication, an agent-generated valuation estimate for a property and a self-reported confidence level; b. verifying, through a multi-factor location authentication process, that the agent is physically present at the property location, wherein the verification comprises: i. validating GPS coordinates against property boundaries; ii. cross-referencing cellular network triangulation data; iii. analyzing device orientation and environmental sensor readings; iv. verifying reasonable transition timing from previous check-ins; c. storing the valuation estimate and confidence level in an encrypted database with row-level security controls; d. computing, using a machine learning model trained on historical property data: i. an initial accuracy metric by comparing the valuation estimate to multiple reference price sources; ii. a confidence calibration factor by calculating a statistical correlation between the agent's self-reported confidence level and actual historical accuracy; e. updating, through a Bayesian inference algorithm, an agent competency score based on: i. the initial accuracy metric; ii. the confidence calibration factor; iii. dynamically adjusted weighting parameters optimized through gradient descent; f. receiving notification of the property's final sale price through a verified external data source; g. calculating a final accuracy metric by comparing the original estimate to the actual sale price; h. computing a token reward amount based on the final accuracy metric and the agent competency score; i. transmitting only the token reward transaction data to a blockchain network through a one-way data diode architecture; j. recording the reward transaction on the blockchain without exposing any sensitive property or agent data; k. updating the agent's competency score in the secure database based on the final accuracy metric.

10. The method of claim 9, further comprising implementing an anti-gaming protocol that: a. restricts each agent to a single estimate submission per property; b. applies statistical outlier detection algorithms to identify suspicious valuation patterns; c. implements temporal constraints requiring minimum realistic property inspection times; d. analyzes agent activity patterns using machine learning to detect potentially fraudulent behavior; e. adjusts scoring weights for submissions flagged as potentially manipulative.

11. The method of claim 9, wherein updating the agent competency score comprises: a. calculating multiple specialized scoring components including: i. estimate price accuracy relative to final sale price; ii. historical estimation accuracy weighted by recency; iii. geographic specialization accuracy within defined submarkets; iv. property type specialization accuracy across categories; v. general estimation activity volume and consistency; b. applying dynamically optimized weights to each component determined through machine learning analysis of predictive power; c. multiplying the combined score by a confidence calibration factor that measures the agent's metacognitive accuracy; d. normalizing the resulting score on a 0-100 scale with statistical adjustments for market conditions.

12. The method of claim 9, wherein the machine learning model: a. processes raw property and agent data through a feature engineering pipeline that: i. normalizes numerical values to appropriate scales; ii. encodes categorical variables using target encoding; iii. generates temporal features capturing market velocity; iv. creates interaction terms between agent experience and property characteristics; b. implements a hybrid architecture combining: i. gradient-boosted decision trees for feature selection; ii. neural networks with multiple hidden layers for complex pattern recognition; c. applies regularization techniques including: i. L2 regularization to prevent overfitting; ii. dropout layers for neural network robustness; iii. early stopping based on validation performance; d. undergoes periodic retraining with new market data to maintain relevance.

13. The method of claim 9, wherein recording the reward transaction on the blockchain comprises: a. executing a formally verified smart contract that: i. validates the reward calculation without accessing underlying estimation data; ii. distributes tokens according to the predetermined reward formula; iii. records the transaction with appropriate metadata for future verification; b. implementing transaction batching that: i. combines multiple reward distributions within defined time windows; ii. optimizes gas usage and computational efficiency; iii. maintains individual reward traceability through metadata; c. maintaining a cryptographic audit trail that allows verification of reward correctness without exposing sensitive data.

14. The method of claim 9, further comprising implementing a confidence tiering system that: a. categorizes agents into confidence calibration tiers based on the statistical correlation between their self-reported confidence and actual accuracy; b. applies tier-specific reward multipliers that incentivize accurate self-assessment; c. dynamically updates an agent's tier classification following each verified transaction; d. provides feedback mechanisms to help agents improve their self-assessment accuracy.

15. The method of claim 9, further comprising implementing a secure database architecture that: a. partitions sensitive and non-sensitive data across logically separated database instances; b. implements row-level encryption for all personal and property-specific data; c. manages database access through role-based permissions with granular access controls; d. prevents SQL injection through parameterized query execution and input validation; e. optimizes read performance through caching layers with automatic invalidation triggers.

16. A non-transitory computer-readable medium storing instructions that, when executed by one or more processors, cause the one or more processors to perform operations comprising: a. receiving, through a secure network interface, an agent-generated valuation estimate for a property, wherein the estimate includes both a price prediction and a self-reported confidence level; b. verifying the agent's physical presence at the property through a multi-factor location authentication process; c. storing the validated estimate in an encrypted database with row-level security controls; d. computing an agent competency score through a machine learning model that integrates estimation accuracy, confidence calibration, and specialized expertise factors; e. upon verification of the property's final sale price: i. calculating a final accuracy metric comparing the estimate to the actual sale; ii. computing a token reward amount based on the accuracy metric and competency score; iii. recording only the reward transaction on a blockchain ledger without exposing sensitive data; f. updating the agent's competency score based on the final accuracy results.

17. The computer-readable medium of claim 16, wherein the instructions further cause the one or more processors to: a. implement a machine learning model for competency scoring that: i. processes agent and property data through a feature engineering pipeline; ii. utilizes a hybrid architecture combining gradient-boosted trees and neural networks; iii. applies regularization techniques to prevent overfitting; iv. undergoes periodic retraining with optimization of weighting parameters; b. calculate multiple specialized scoring components including: i. estimate price accuracy relative to final sale price; ii. historical estimation accuracy weighted by recency; iii. geographic and property-type specialization accuracy; iv. general estimation activity metrics; c. apply dynamically optimized weights to each component determined through machine learning; d. multiply the combined score by a confidence calibration factor measuring metacognitive accuracy.

18. The computer-readable medium of claim 16, wherein verifying the agent's physical presence comprises: a. validating GPS coordinates against property boundaries with appropriate tolerance; b. cross-referencing cellular network triangulation when available; c. analyzing device orientation and environmental sensor readings for consistency; d. implementing time-based constraints on property transitions; e. detecting potential GPS spoofing through pattern analysis and inconsistency checking.

19. The computer-readable medium of claim 16, wherein recording the reward transaction on the blockchain comprises: a. executing a smart contract with formal verification of mathematical correctness; b. implementing transaction batching for computational efficiency; c. maintaining a cryptographic audit trail allowing verification without exposing sensitive data; d. utilizing a permissioned blockchain with Byzantine Fault Tolerance consensus.

20. A system for incentivizing accurate real estate valuations using a distributed architecture, comprising: a. means for securely receiving property valuation estimates from authenticated real estate agents; b. means for verifying agent physical presence at property locations through multi-factor authentication; c. means for securely storing estimation data and agent metrics in an encrypted database; d. means for computing agent competency scores using machine learning models trained on historical transaction data; e. means for calculating confidence calibration factors by correlating self-reported confidence with actual accuracy; f. means for securely distributing token rewards through a blockchain network without exposing sensitive property or agent data; g. means for preventing system gaming through anomaly detection and behavioral analysis; h. means for optimizing scoring algorithms through dynamic weight adjustment and periodic model retraining.
